(19) United States
(12) Patent Application Publication
(10) Pub. No.: US 2014/0293848 A1
(43) Pub. Date: Oct. 2, 2014

(54) COMMUNICATION DEVICE DATA CHANNEL ACCESS

(71) Applicant: Alcatel-Lucent USA Inc., Murray Hill, NJ (US)

(72) Inventor: Douglas W. Varney, Naperville, IL (US)

(21) Appl. No.: 13/852,849

(22) Filed: Mar. 28, 2013

(51) Int. Cl. H04W 52/02

(52) U.S. Cl. CPC H04W 52/0251
USPC 370/311

(57) ABSTRACT

A communication device of an apparatus in one example comprises a radio interface for wireless data transfers over a data channel. The communication device comprises a data channel module adapted to receive at least one data channel request. The data channel request comprises a request for access to the data channel from an application executable on the communication device. The data channel module is adapted to maintain a deferred request list. The data channel module is adapted to determine whether to defer the access to the data channel for the data channel request. The data channel module is adapted to add the application to the deferred request list upon a determination to defer the access for that data channel request.

### BACKGROUND

For mobile devices that transfer data over a radio interface technology, such as code division multiple access (CDMA) or Wideband-CDMA (WCDMA), there may be a high setup cost for a data channel but a relatively low transfer cost once the channel is established. The data channel is released after a period of inactivity. For data streams of longer duration, such as a voice call or video stream, the setup cost is less of a concern. However, many mobile devices have applications (“apps”) that transfer small amounts of data, particularly as a background process, and then do not use the data channel for a period of time. Where several apps independently transfer a small amount of data, there may be many setups and releases as each app performs a transfer.

In addition to the setup cost, the amount of power and thus use of the mobile device's battery in transferring data over technologies such as W-CDMA and CDMA is generally proportional to the amount of time the data channel is up. If an application is not designed for wireless networks, then it may excessively use the data channel with background activities or tasks that do not directly impact the user interface or user's experience. Further, because of the high setup costs, there is usually a timer (e.g., an inactivity or guard timer) that is set after every use of the data channel so that a subsequent use does not need to incur setting up the data channel again. In current networks that timer is typically set to 10 seconds. Thus after the last bit is sent or received, the data channel remains up for that period of time. Even when no data is transmitted, there is significant power usage occurring to keep the data channel up.

As mobile devices become more like computer platforms they support the ability for many applications to be resident and running This has allowed for a great increase in the number of applications on mobile devices. A potential characteristic of these applications is to send a request to a remote server for up-to-date information. This may be performed when the application is in the foreground or also as a background task. Although the amount of data transferred as a result of these requests may be small, a large number of applications in combination with the inactivity timer keeping the data channel up often results in considerable battery drain.

One solution to reduce battery usage of a mobile device is the strict design and screening of mobile device applications so that they minimize battery usage—especially for background tasks. For example, applications may be developed with application programming interfaces (APIs) that allow them to indicate the end of a data transfer or other mechanisms that make data transfers more efficient. After the last application using a data channel indicates it has finished (or the inactivity timer fires), the data channel may be closed. This reduces the amount of time the data channel stays open, draining the battery, without any data being transferred.

However, many applications may simply use source code originally designed for a wired computer that has been ported to a mobile device without modifications for efficient battery or wireless network usage. Existing applications would need to be modified or re-written to use these APIs. Additionally, the API does not address the problem of each application acting independently and thus performing its own setup and release for the data channel.

Another solution is to use technology where an external server determines that the application on the mobile device needs to be updated and triggers that update. This removes the need for the application to “check-in” with the server that is a common source of battery drain. In particular, a Push Notification System (PNS) may be configured to receive respective requests for a data session over a data channel from multiple applications on the mobile device. However, this solution requires a Push Notification Server to be deployed within the network. Further changes to application servers within the network must also be implemented for cooperation with the Push Notification Server. The mobile device applications still need to be written to take advantage of a Push Notification System. Additionally, applications that need to be triggered independently of the application server would not receive a benefit.

### SUMMARY

In one embodiment, there is provided an apparatus comprising a communication device with a radio interface for wireless data transfers over a data channel. The communication device comprises a data channel module adapted to receive at least one data channel request. The data channel request comprises a request for access to the data channel from an application executable on the communication device. The data channel module is adapted to maintain a deferred request list. The data channel module is adapted to determine whether to defer the access to the data channel for the data channel request. The data channel module is adapted to add the application to the deferred request list upon a determination to defer the access for that data channel request.

In another embodiment, there is provided a method. A data channel request is received, from an application running on a communication device, at a data channel module of the communication device. The communication device comprises a radio interface for wireless data transfers over a data channel. The data channel request comprises a request for access to the data channel from the application. A deferred request list is maintained by the data channel module. A determination is made by the data channel module whether to defer the access to the data channel for the data channel request. The application is added by the data channel module to the deferred request list upon a determination to defer the access for that data channel request.

In yet another embodiment, there is provided an article comprising at least one non-transitory processor-readable media storing instructions which, when executed by a processor, cause the processor to perform a method. A data channel request is received, from an application running on a communication device, at a data channel module of the communication device. The communication device comprises a radio interface for wireless data transfers over a data channel. The data channel request comprises a request for access to the data channel from the application. A deferred request list is maintained by the data channel module. A determination is made by the data channel module whether to defer the access to the data channel for the data channel request. The application is added by the data channel module to the deferred request list upon a determination to defer the access for that data channel request.

### DESCRIPTION OF THE DRAWINGS

Features of example implementations of the invention will become apparent from the description, the claims, and the accompanying drawings in which:

FIG. 1 is a representation of a wireless communication device of the prior art and illustrates individual applications accessing a radio interface of the wireless communication device.

FIG. 2 is a representation of one implementation of a communication device and illustrates access to a radio interface through a data channel module of the communication device.

FIG. 3 is a representation of one implementation of the communication device of FIG. 2 with a wireless network.

FIG. 4 is a representation of one process flow for access to the radio interface through the data channel module of FIG. 2.

FIG. 5 is a representation of one example of data channel uptime in response to requests for access to the data channel by multiple applications.

### DETAILED DESCRIPTION

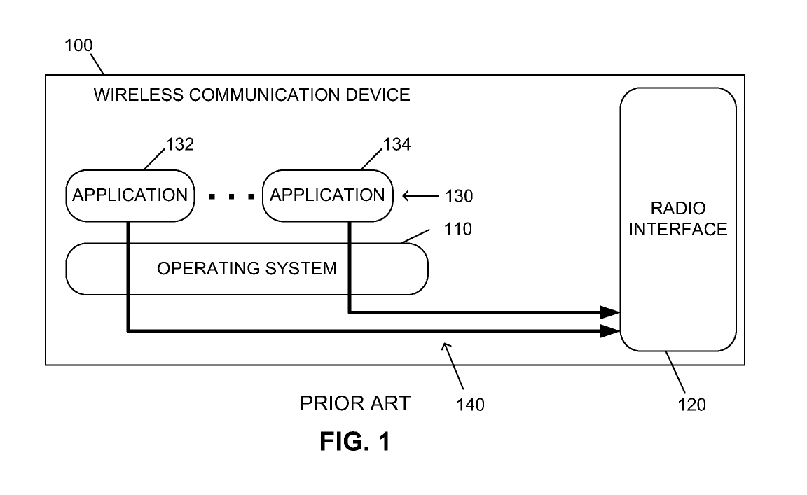

Turning to FIG. 1, a wireless communication device 100 of the prior art is shown as various modules running within the wireless communication device 100. The wireless communication device 100 comprises an operating system 110 that provides basic functionality for the wireless communication device 100, such as handling phone calls or transferring data over a wireless network (not shown). The wireless communication device 100 comprises a radio interface 120 for communication with the wireless network. As described in the Background, the wireless communication device 100 may execute or run a plurality of applications 130, such as applications 132 and 134. In order for the applications 130 to transfer data with the wireless network, they must communicate with the operating system 110 to gain access to the radio interface 120. Each application (132, 134) communicates with the operating system 110 directly and independently to gain access, via separate communication paths 140.

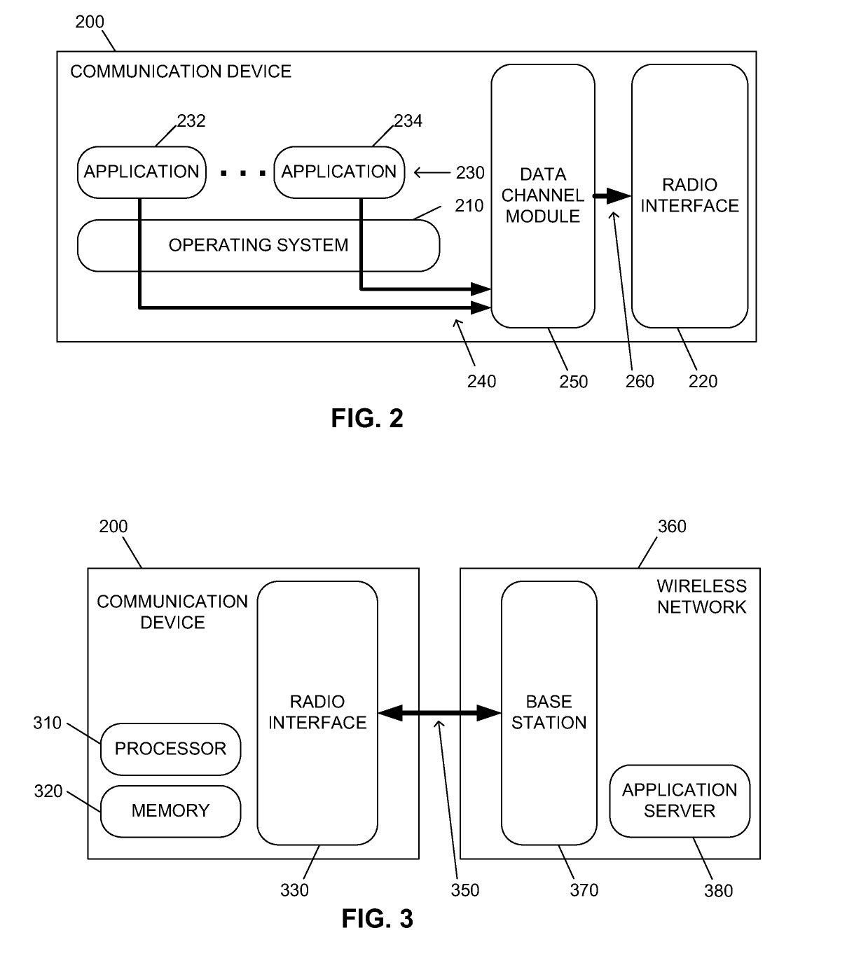

Turning to FIG. 2, one embodiment of a communication device 200 is shown. The communication device 200 in one implementation comprises a wireless communication device 200 such as a mobile phone (e.g., an Android, Blackberry, iOS, or Windows Mobile device), personal digital assistant (PDA), tablet, wireless-enabled computer, or other device enabled for wireless communication. In alternative implementations, the wireless communication device 200 may be in a generally fixed location, such as a desktop computer, wireless router, wireless-enabled appliance (e.g., television, digital video recorder, home security system), or similar devices known to those skilled in the art.

The wireless communication device 200 comprises an operating system 210 that provides functionality for the wireless communication device 200, such as handling phone calls (e.g., for a mobile phone or tablet) and/or transferring data over a wireless network 360 (FIG. 3). The wireless communication device 200 comprises a radio interface 220 for communication (e.g., wireless data transfers) over a data channel 350 (FIG. 3) with the wireless network 360. The radio interface 220 and wireless network 360 in one example cooperate as parts of a code division multiple access (CDMA) network, Wideband-CDMA (W-CDMA) network, Enhanced Data rates for GSM Evolution (EDGE) network, universal mobile telecommunication system (UMTS) network, long term evolution (LTE) network, Worldwide Interoperability for Microwave Access (WiMAX) network, Wi-Fi network, or other radio access standards promulgated by the 3^{rd} Generation Partnership Project (3GPP), the International Telecommunication Union (ITU), the Institute of Electrical and Electronics Engineers (IEEE), or other standards groups, as will be appreciated by those skilled in the art. The radio interface 220 in one example is adapted to communicate with multiple instances of the wireless network 360 and optionally, multiple radio access technologies or frequency bands. For example, the radio interface 220 may be adapted to alternately or concurrently operate over CDMA, LTE, and WiFi networks.

The wireless communication device 200 in one implementation is adapted to execute or run a plurality of applications 230, such as applications 232 and 234. In the wireless communication device 200, the applications 230 may request access to the radio interface 220 by sending data channel requests through communication paths 240. The wireless communication device 200 comprises a data channel module (DCM) 250. The DCM 250 in one example is adapted to receive communications from the applications 230 over the communication paths 240. The DCM 250 in a further example is adapted to grant, defer, and/or deny access to the data channel 350 for data channel requests received from the applications 230, as will be appreciated by those skilled in the art.

The DCM 250 in one implementation comprises an application programming interface (API). The applications 230 may be written, compiled, or otherwise adapted to interact with the DCM 250 through the API. In this implementation, the DCM 250 receives the data channel requests from the applications 230 or in cooperation with the operating system 210. In another implementation, the DCM 250 is adapted to intercept the data channel requests. For example, where the application 232 is not designed to interact with the API, the application 232 may attempt to send data channel requests to the operating system 210 or directly to the radio interface 220. In this example, the DCM 250 intercepts data channel requests from the application 232, as will be appreciated by those skilled in the art.

The DCM 250 in one implementation provides a path, such as interface 260, for the applications 230 to access the radio interface 220. Accordingly, the DCM 250 may act as a gateway or controller for granting, deferring, and/or denying access to the data channel 350. Where the radio interface 220 is adapted to communicate with multiple instances of the wireless network 360, the wireless communication device 200 may comprise multiple instances of the DCM 250 (e.g., one DCM per wireless network) or alternatively, one or more DCMs adapted to provide the access to multiple wireless networks. In the implementation shown in FIG. 2, a single DCM 250 is employed to communicate with each instance of a wireless network 360.

Turning to FIG. 3, one implementation of the wireless communication device 200 is shown along with a wireless network 360. In this implementation, the wireless communication device 200 comprises at least one processor 310, at least one memory 320, and at least one radio interface 330. The processor 310 and memory 320 in one example are adapted to store and execute code, such as the operating system 210 and/or applications 230. The radio interface 330 in one example comprises hardware and/or software for wireless communication with the wireless network 360. Multiple instances of the radio interface 330 may be respectively adapted to provide communication with a particular instance of the wireless network 360, or may be adapted to provide communication with multiple instances of the wireless network.

The DCM 250 may be implemented as hardware (e.g., an application specific integrated circuit or processor), as processor-executable code (e.g., software, firmware, or other code adapted to run on the processor 310), or a combination thereof. The DCM 250 may be implemented separately from the operating system 210 or as a portion of the operating system 210, such as a software module. In one example, the operating system 210, applications 230, and DCM 250 are executable on a single processor 310. In other examples, the operating system 210, applications 230, and DCM 250 may be distributable across multiple, dedicated and/or shared processors.

The data channel 350 and radio interface 220 in on example provide the “air interface” to the wireless network 360. The data channel 350 may be in an “active” state or “inactive” state. When active, the data channel 350 is ready to transfer or actively transferring data with the wireless network 360. When inactive, the data channel 350 is not ready to transfer data with the wireless network 360. The radio interface 220 consumes more power when the data channel 350 is active than when inactive, as will be understood by those skilled in the art. As described herein, the DCM 250 in one example grants or defers access to the data channel 350 to reduce the amount of time the data channel 350 is active and thus reduce the overall power consumption of the radio interface 220.

The wireless network 360 in one example comprises a base station 370 for wireless communication with the wireless communication device 200. Examples of the base station 370 include a base transceiver station (BTS), Node B, evolved Node B (eNodeB), and other base stations as will be appreciated by those skilled in the art. The wireless network 360 in one example further comprises at least one application server 380. Additional network components, not shown, may be present in the wireless network 360, such as mobile switching centers, home location registers, Serving GPRS Support Node (SGSN), Gateway GPRS Support Node (GGSN), and others as will be understood by those skilled in the art.

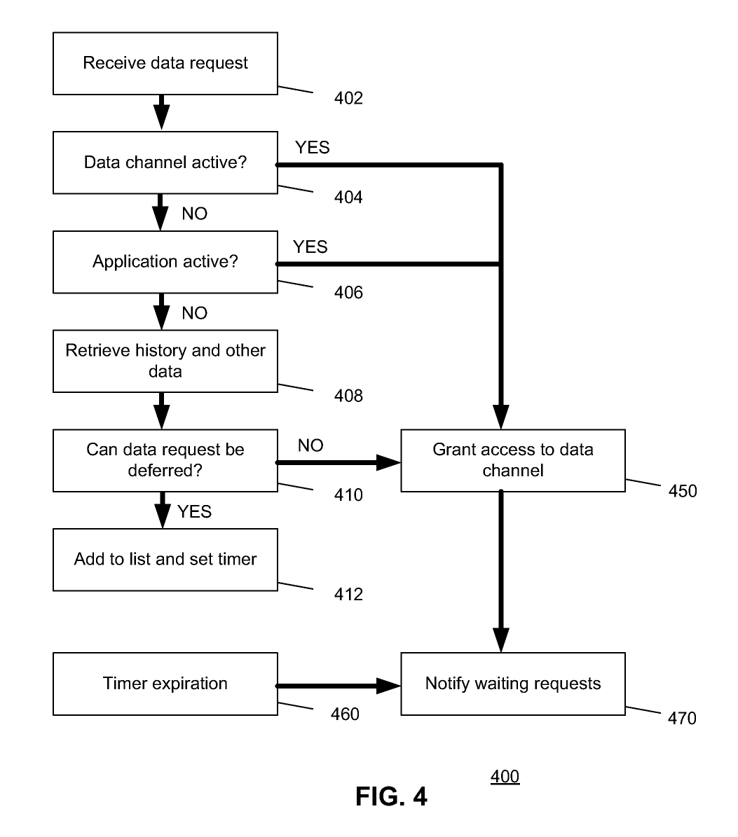

An illustrative description of operation of the wireless communication device 200 is presented, for explanatory purposes. Turning to FIG. 4, one implementation of a process flow 400 is shown. The process flow 400 in one example is performed by the communication device 200. For example, the DCM 250 may perform the process flow 400, either alone or in combination with the operating system 210. At STEP 402, the DCM 250 receives a data channel request, for example, from the application 232. As described above, the DCM 250 may receive the data channel request through an API or it may intercept the data channel request. Where the DCM 250 is adapted to intercept data channel requests, it may actively prevent direct access by the applications 230 to the radio interface 220.

The DCM 250 in one implementation then determines (STEP 404) whether the data channel 350 is active, for example, currently active and available for data transfer. If the data channel 350 is active, the DCM 250 grants (STEP 450) access to the application 232. Since activating the data channel 350 consumes more power, where the data channel 350 is already active, it can be used more efficiently by the current data channel request rather than with a separate activation of the data channel 350.

If the data channel 350 is not active, the DCM 250 determines (STEP 406) whether the application 232 is active, for example, whether the application 232 is currently running in a foreground or background of the wireless communication device 200, as will be understood by those skilled in the art. If the application 232 is running in the foreground, the DCM 250 grants access (STEP 450). This reduces the likelihood that a user of the wireless communication device 200 is negatively impacted by a deferral of access to the data channel 350, such as slow response time in a user interface experience for the user.

If the application 232 is not active, the DCM 250 in one example is adapted to determine (STEP 410) whether the data channel request may be performed as requested or can otherwise be deferred until a later time. This determination may be based on a retrieved (STEP 408) data transfer history of data channel requests from the application 232, such as their frequency of data usage, context of the usage, amount of data transferred, the network type (e.g., whether the data channel 350 is through a CDMA network, LTE network, etc.), and other factors as will be appreciated by those skilled in the art. The history may provide information that refines the decision on whether the application 232 is currently doing a deferrable task. In addition, the DCM 250 in one example comprises a user interface (not shown) that allows the user of the wireless communication device 200 to set a preference for a selected application for the determination of whether to defer the access to the data channel 350. For example, the user may wish to indicate that a selected application should always be allowed access and never deferred.

The DCM 250 in one example stores the history of the data channel requests from one or more of the applications 230. For example, where the application 232 sends a data channel request substantially periodically, such as every 30 minutes regardless of whether the application 232 is currently active, the DCM 250 may determine that the data channel request can be deferred until a later time. Data channel requests only received when the wireless communication device 200 is active would likely indicate preparing for a user interaction and thus not a deferrable task. If the data channel request cannot be deferred, the DCM 250 grants access (STEP 450). In another example, the application server 380 is adapted to store the history. In this example, the application server 380 may comprise a Wireless Network Guardian (Alcatel-Lucent, Murray Hill, N.J.) adapted to store the history. The DCM 250 retrieves (STEP 408) the history of the application 232 from the application server 380, either prior to or upon the receipt of the data channel request. Where the application server 380 stores the history, it may compile data channel requests from multiple instances of the applications 230 running on a plurality of wireless communication devices 200, as will be appreciated by those skilled in the art.

The DCM 250 in one example is adapted to maintain a deferred request list. Upon a determination to defer the access for the data channel request, the DCM 250 is adapted to add (STEP 412) the application 232 to the deferred request list. The list in one example comprises a callback function for the application 232, a reference to the data channel request, a reference to the application 232, or other indicator sufficient to notify the application 232 as described herein, as will be appreciated by those skilled in the art.

The DCM 250 in one example is adapted to set an access timer. The DCM 250 may start the access timer upon adding (STEP 412) an application to the deferred request list. The access timer may be a fixed timer such as 40 milliseconds, 3 seconds, up to several minutes, or other times as will be appreciated by those skilled in the art. In another example, the access timer may be set dynamically, based on application usage, network connectivity, or other factors. For example, a longer duration timer may be used for data transfers with a CDMA network than with an LTE network. The DCM 250 may optionally be adapted to set the access timer in order to balance signaling to the wireless network 360 along with battery consumption on the wireless communication device 200.

When adding subsequent applications to the deferred request list, i.e. after the access timer has been started, the DCM 250 in one example updates the access timer. For example, the DCM 250 may reduce the access timer such that it expires more quickly, thus reducing the delay when multiple applications have been deferred. In further examples, the DCM 250 may set the access timer such that the expiration coincides with an existing timer of the wireless communication device, such as a discontinuous reception (DRX) timer, an end of an “idle” or “disconnected” state, or others, as will be appreciated by those skilled in the art.

Upon expiration of the access timer (STEP 460), the DCM 250 is adapted to activate the data channel 350 (if inactive) and to notify (STEP 470) the applications within the deferred request list to grant them access to the data channel 350. Advantageously, this allows multiple applications to use a single instance of an active data channel, as opposed to multiple active instances, saving battery life of the wireless communication device, as will be appreciated by those skilled in the art.

The DCM 250 in another example is adapted to monitor the data channel 350 for its status, such as being active or inactive. Upon a change to active status, the DCM 250 notifies (STEP 470) the applications within the deferred request list to grant them access to the data channel 350, clears the access timer, and removes the applications from the deferred request list.

The DCM 250 in one example is adapted to anticipate whether all the applications have finished transferring data, for example, based on the stored history. In this example, the DCM 250 may request, optionally after a guard timer, that the radio interface 220 close the data channel 350.

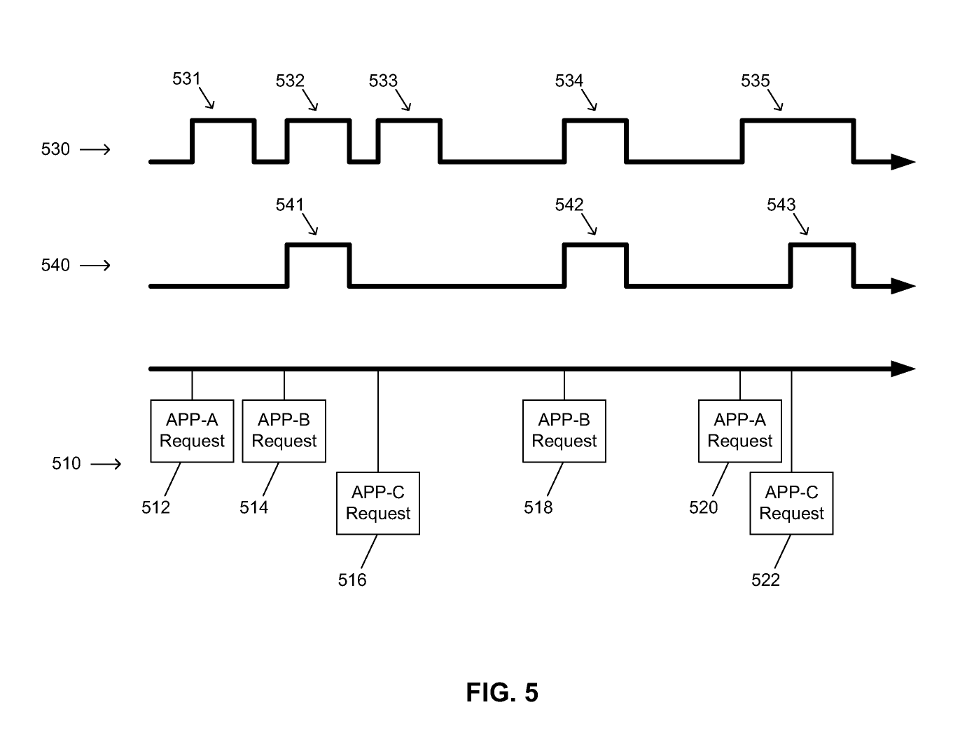

Turning to FIG. 5, a comparison of data channel activity 530 of the wireless communication device 100 with data channel activity 540 of the wireless communication device 200 is shown for a timeline of example data channel requests 510. The timeline 510 comprises data channel requests 512 and 520 from a first Application A, data channel requests 514 and 518 from a second Application B, and data channel requests 516 and 522 from a third Application C.

The data channel activity 530 responds directly to each data channel request of the timeline 510. While the data channel requests 520 and 522 provide some overlap in data channel activity, the data channel activity 530 indicates an activation of the data channel at 531, 532, 533, 534, and 535. In contrast, the data channel activity 540 of the wireless communication device 200 shows that data channel requests 512, 516, and 520 are deferred and granted access at a later time, concurrently with another application. Accordingly, the data channel activity 540 has fewer activations of the data channel 350 and thus reduced battery consumption for the same data transfers. This benefit is then multiplied with increasing numbers of applications.

The DCM 250 enables extended battery life for wireless communication devices and reduces radio resource usage in circumstances where many applications run concurrently, in a multi-tasking fashion, or otherwise executing background tasks for data transfer. Advantageously, the DCM 250 provides extended battery life and reduced radio resource usage even if the applications 230 are not optimized to wireless environments. This is to the benefit of network operators and wireless device manufacturers to mitigate dissatisfiers like short battery life caused by applications that neither party has control over.

The apparatus 200 in one example comprises a plurality of components such as one or more of electronic components, hardware components, and computer software components. A number of such components can be combined or divided in the apparatus 200. An example component of the apparatus 200 employs and/or comprises a set and/or series of computer instructions written in or implemented with any of a number of programming languages, as will be appreciated by those skilled in the art.

The wireless communication device 200 in one example employs one or more processor-readable non-transitory media. The processor-readable non-transitory media store software, firmware, assembly language, and/or code for performing one or more portions of one or more implementations of the invention. Examples of a processor-readable non-transitory medium for the wireless communication device 200 comprise the memory 320. The processor-readable non-transitory medium for the wireless communication device 200 in one example comprise one or more of a magnetic, electrical, optical, biological, and atomic data storage medium. For example, the processor-readable non-transitory media comprise flash memory, hard disk drives, solid state disks, floppy disks, magnetic tapes, CD-ROMs, DVD-ROMs, or other electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a communication device with a radio interface for wireless data transfers over a data channel;
wherein the communication device comprises a data channel module adapted to receive at least one data channel request, wherein the data channel request comprises a request for access to the data channel from an application executable on the communication device;
wherein the data channel module is adapted to maintain a deferred request list;
wherein the data channel module is adapted to determine whether to defer the access to the data channel for the data channel request;
wherein the data channel module is adapted to add the application to the deferred request list upon a determination to defer the access for that data channel request.

2. The apparatus of claim 1, wherein the data channel module is adapted to determine whether the data channel is active or inactive;
wherein the data channel module is adapted to grant the access to the data channel to the application if the data channel is active.

3. The apparatus of claim 1, wherein the data channel module is adapted to determine whether the application is running in a foreground or background of the communication device;
wherein the data channel module is adapted to grant the access to the data channel if the application is running in the foreground;
wherein the data channel module is adapted to defer the access to the data channel if the application is running in the background.

4. The apparatus of claim 1, wherein the data channel module is adapted to determine whether the data channel request is performable as a deferrable task;
wherein the data channel module is adapted to grant the access to the data channel if the data channel request is not performable as a deferrable task;
wherein the data channel module is adapted to defer the access to the data channel if the data channel request is performable as a deferrable task.

5. The apparatus of claim 4, wherein the data channel module is adapted to use a data transfer history for the application to determine whether the data channel request is performable as a deferrable task;
wherein a data transfer history for the application that includes substantially periodic data channel requests is determined to be performable as a deferrable task.

6. The apparatus of claim 1, wherein the data channel module is adapted to set an access timer upon adding the application to the deferred request list;
wherein the data channel module is adapted to activate the data channel upon expiration of the access timer;
wherein the data channel module is adapted to notify each application in the deferred request list upon expiration of the access timer to grant each application access to the data channel.

7. The apparatus of claim 6, wherein the data channel module is adapted to update the access timer upon adding another application to the deferred request list.

8. The apparatus of claim 6, wherein the data channel module is adapted to set the access timer such that the expiration thereof substantially coincides with an expiration of an existing timer associated with the radio interface.

9. The apparatus of claim 1, wherein the data channel module is adapted to monitor for a change in status of the data channel from inactive to active;
wherein the data channel module is adapted to notify each application in the deferred request list, upon the change in status from inactive to active, to grant each application access to the data channel.

10. The apparatus of claim 1, wherein the data channel module is adapted to intercept data channel requests sent from the application to the radio interface.

11. The apparatus of claim 1, wherein the data channel module comprises a user interface adapted to allow a user of the communication device to set a preference for a selected application for the determination of whether to defer the access to the data channel.

12. The apparatus of claim 1, wherein the data channel module is adapted to determine whether to deny the access to the data channel for the data channel request.

13. The apparatus of claim 1, wherein the data channel module is adapted to determine whether to grant the access to the data channel for the data channel request.

14. A method, comprising the steps of:
receiving a data channel request, from an application running on a communication device, at a data channel module of the communication device, wherein the communication device comprises a radio interface for wireless data transfers over a data channel, wherein the data channel request comprises a request for access to the data channel from the application;
maintaining, by the data channel module, a deferred request list;
determining, by the data channel module, whether to defer the access to the data channel for the data channel request;
adding, by the data channel module, the application to the deferred request list upon a determination to defer the access for that data channel request.

15. The method of claim 14, wherein the step of determining whether to defer comprises the steps of:
determining, by the data channel module, whether the data channel is active or inactive;
granting, by the data channel module, the access to the data channel to the application if the data channel is active.

16. The method of claim 14, wherein the step of determining whether to defer comprises the steps of:
determining, by the data channel module, whether the application is running in a foreground or background of the communication device;
granting the access to the data channel if the application is running in the foreground; and
deferring the access to the data channel if the application is running in the background.

17. The method of claim 14, wherein the step of determining whether to defer comprises the steps of:
determine whether the data channel request is performable as a deferrable task;
granting the access to the data channel if the data channel request is not performable as a deferred task;
deferring the access to the data channel if the data channel request is performable as a deferrable task.

18. The method of claim 14, wherein the step of maintaining the deferred request list comprises the steps of:
setting an access timer upon adding the application to the deferred request list;
activating the data channel upon expiration of the access timer; and
notifying each application in the deferred request list upon expiration of the access timer to grant each application access to the data channel.

19. The method of claim 18, further comprising the steps of:
monitoring for a change in status of the data channel from inactive to active;
notifying each application in the deferred request list, upon the change in status from inactive to active, to grant each application access to the data channel.

20. An article, comprising:
at least one non-transitory processor-readable media storing instructions which, when executed by a processor, cause the processor to perform a method comprising the steps of:
receiving a data channel request, from an application running on a communication device, at a data channel module of the communication device, wherein the communication device comprises a radio interface for wireless data transfers over a data channel, wherein the data channel request comprises a request for access to the data channel from the application;
maintaining, by the data channel module, a deferred request list;
determining, by the data channel module, whether to defer the access to the data channel for the data channel request;
adding, by the data channel module, the application to the deferred request list upon a determination to defer the access for that data channel request.

21. The article of claim 20, the non-transitory processor-readable media storing instructions which, when executed by the processor, cause the processor to perform the steps of:
setting an access timer upon adding the application to the deferred request list;
activating the data channel upon expiration of the access timer; and
notifying each application in the deferred request list upon expiration of the access timer to grant each application access to the data channel.
